(19) United States
(12) Patent Application Publication
(10) Pub. No.: US 2007/0075289 A1
(43) Pub. Date: Apr. 5, 2007

(54) Coolant composition for fuel cell

(76) Inventors: Hiroshi Egawa, Gifu (JP); Nobuyuki Kaga, Gifu (JP)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 11/524,140

(22) Filed: Sep. 20, 2006

Related U.S. Application Data
(63) Continuation-in-part of application No. PCT/JP04/04101, filed on Mar. 24, 2004.

(51) Int. Cl. C09K 5/00; H01M 8/00

(52) U.S. Cl. 252/73; 429/13

(57) ABSTRACT

Coolant compositions for fuel cells having at least one sugar alcohol in a base component that resist oxidation of the base component and the rise of the electric conductivity of the coolant when the fuel cell is in use. Fuel cells including coolant compositions having at least one sugar alcohol in a base component. Methods of making fuel cells including coolant compositions having at least one sugar alcohol in a base component.

### CROSS REFERENCE TO RELATED PATENT APPLICATION

This application is a continuation-in-part of copending international patent application PCT/JP2004/004101 entitled “Coolant Composition For Fuel Cell” filed Mar. 24, 2004, the disclosure of which is hereby incorporated herein by reference. This application is related to U.S. patent application Ser. No. 11/121,358 filed May 4, 2005, U.S. patent application Ser. No. 11/330,015 filed Jan. 11, 2006, U.S. patent application Ser. No. 11/395,106, filed Mar. 31, 2006, and U.S. patent application Ser. No. 11/441,550, filed May 26, 2006 entitled “COOLANT COMPOSITION”, the disclosures of which are each hereby incorporated herein by reference.

### TECHNICAL FIELD

This invention generally relates to a coolant composition for cooling fuel cells, particularly for cooling automotive fuel cells, which is capable of effectively inhibiting oxidation of the base component of the coolant composition and maintaining the electric conductivity of the coolant effectively low enough for a long period of time.

### BACKGROUND ART

A fuel cell unit generally comprises a plurality of individual fuel cells arranged in stacks, which generates heat as it generates electric power. In order to cool the stacked fuel cells, a cooling plate is provided among every few fuel cells. Such a cooling plate is provided with a winding coolant path or paths where coolant circulates and cools the adjacent fuel cells.

If the electric conductivity of the coolant, which circulates through the cooling plates within the fuel cell unit, is “high”, the electricity generated in the fuel cell unit leaks into the coolant in the coolant paths, detrimentally lowering the efficiency of the fuel cell unit. Accordingly, pure water, which is “low” in electric conductivity and thus highly insulative, has been generally used as coolant for fuel cell units.

However, in the case of a fuel cell unit which is used intermittently, such as an automotive fuel cell unit, or a fuel cell unit for a cogeneration system for home use, the temperature of coolant circulating in the fuel cell unit falls to or close to the atmospheric temperature when the fuel cell unit is not in use. When the fuel cell unit where pure water is used as coolant is kept at rest for long below the water freezing point, the pure water coolant gets frozen and likely damages the fuel cell unit physically by expansion and deteriorates the performance of the fuel cell unit.

In order to prevent such damages and deterioration, use of a glycol or alcohol as a base component may be considered.

However, a glycol or alcohol, when used as a base component of coolant for a fuel cell unit, will produce ionic substances in the coolant from oxidation of such a base component, which may be negligible at first, though. The produced ionic substances will eventually accumulate and gradually but steadily raise the electric conductivity of the coolant.

In order to prevent such accumulation of ionic substances, removing the ionic substances by arranging ion exchange resin filters in the coolant paths of a fuel cell system may be considered.

However, ion exchange resin filters are fast degraded through use because the resin is consumed through removal of the ionic substances produced by the oxidation of the base component, quickly losing their effectiveness.

Accordingly, it is an object of the present invention to provide a coolant composition for fuel cells, which is capable of effectively inhibiting oxidation of the base component of the coolant composition and maintaining the electric conductivity of the coolant effectively low for an extended period of time.

### SUMMARY OF THE INVENTION

The coolant composition of the present invention is characterized by containing at least one specific sugar alcohol in the base component. The base component of the coolant composition of the present invention has a low electric conductivity and sufficient anti-freezing property. Preferably, the base component of the coolant composition of the present invention comprises at least one component selected from water, alcohols, glycols and glycol ethers.

Such alcohols may be selected from methanol, ethanol, propanol, butanol, pentanol, hexanol, heptanol and octanol.

Such glycols may be selected from ethylene glycol, diethylene glycol, triethylene glycol, propylene glycol, 1,3-propanediol, 1,3-butanediol, 1,5-pentanediol and hexylene glycol.

Such glycol ethers may be selected from ethylene glycol monomethyl ether, diethylene glycol monomethyl ether, triethylene glycol monomethyl ether, tetraethylene glycol monomethyl ether, ethylene glycol monoethyl ether, diethylene glycol monoethyl ether, triethylene glycol monoethyl ether, tetraethylene glycol monoethyl ether, ethylene glycol monobutyl ether, diethylene glycol monobutyl ether, triethylene glycol monobutyl ether, and tetraethylene glycol monobutyl ether.

The coolant composition of the present further contains at least one specific sugar alcohol in its base component to effectively inhibit oxidation of the base component and prevent the electric conductivity from rising beyond an acceptable level or 10 μS/cm in order to maintain the electric power generating capacity of the fuel cell unit above a satisfactory level. The coolant composition of the present invention maintains the electric conductivity within the range 0 μS/cm-10 μS/cm even after a long use.

Such sugar alcohols may be selected from erythritol, xylitol, sorbitol, mannitol, inositol, quercitol, palatinit, lactitol, maltitol, sucrose, raffinose, gentianose, melezitose, planteose and stachyose. Among them, sorbitol mannitol and lactitol are especially preferred as they are excellent in oxidation inhabitation as well as easy to handle and obtain.

Preferably, at least one sugar alcohol is contained in the base component of the coolant composition of the present invention in the range from 0.1 wt % to 20.0 wt % of the base component. Efficient oxidation inhibition will not be provided if the content is below this range and waste will result if the content is above this range.

The coolant composition of the present invention may additionally and selectively contain in its base component an amount of a caustic alkali for pH adjusting, dye, antifoaming agent and/or antiseptic, and/or an antirust agent such as a phosphate, nitrate, nitrite, molybdate, tungstate, borate, silicate, sulfate, sulfite, carbonate, amine salt, and triazole within a range that will not adversely affect the electric conductivity of the coolant composition.

### EMBODIMENTS

The present invention is described in more detail below based on preferred embodiments as compared with comparisons. Table 1 shows the components of preferred embodiments 1-3 of the present invention and comparisons 1-5, where embodiment 1 consisted of a base component of ethylene glycol (antifreeze agent) and ion exchange water and sorbitol, embodiment 2 contained mannitol in an identical base component, embodiment 3 contained lactitol in another identical base component, comparison 1 consisted of only a base component of ethylene glycol and ion exchange water, comparison 2 additionally contained glucose in a base component which is identical with comparison 1, comparison 3 additionally contained mannose in a base material which is identical with comparison 1, comparison 4 additionally contained lactose in a base material which is identical with comparison 1, and comparison 5 additionally contained maltose in a base material which is identical with comparison 1, all at the respectively indicated weight proportions.

TABLE 1
(wt %)

| Component | Emb1 | Emb2 | Emb3 | Cmp1 | Cmp2 | Cmp3 | Cmp4 | Cmp5 |
|---|---|---|---|---|---|---|---|---|
| ethylene glycol | 50 | 50 | 50 | 50 | 50 | 50 | 50 | 50 |
| ion exchange | 50 | 50 | 50 | 50 | 50 | 50 | 50 | 50 |
| water | | | | | | | | |
| sorbitol | 5.0 | — | — | — | — | — | — | — |
| mannitol | — | 5.0 | — | — | — | — | — | — |
| lactitol | — | — | 5.0 | — | — | — | — | — |
| glucose | — | — | — | — | 5.0 | — | — | — |
| mannose | — | — | — | — | — | 5.0 | — | — |
| lactose | — | — | — | — | — | — | 5.0 | — |
| maltose | — | — | — | — | — | — | — | 5.0 |

Oxidation deterioration testing (100° C.; 168 hs) was performed on Embodiments 1-3 and Comparisons 1-5, and their post-testing electric conductivities were measured. The result of the measuring is provided in Table 2.

TABLE 2
(electric conductivity: μS/cm)

| Item | Emb1 | Emb2 | Emb3 | Cmp1 | Cmp2 | Cmp3 | Cmp4 | Cmp5 |
|---|---|---|---|---|---|---|---|---|
| Initial conductivity | 0.4 | OJ | 0.2 | 0.2 | 0.3 | 0.4 | 0.4 | 0.3 |
| conductivity | 3.3 | 9.7 | 2.7 | 42.6 | 46.3 | 53.5 | 47.2 | 45.6 |
| after test | | | | | | | | |

The initial electric conductivities of Embodiments 1-3 and Comparisons 1-5 were all 0.4 μS/cm or below. The electric conductivities of Comparisons 1-5 after testing were all 40 μS/cm or over, while those of Embodiments 1-3 were all below 10 μS/cm.

### EFFECT OF THE INVENTION

The coolant composition according to the present invention comprises at least one sugar alcohol in its base component which is selected from erythritol, xylitol, sorbitol, mannitol, inositol, quercitol, palatinit, lactitol, maltitol, sucrose, raffinose, gentinose, melezitose, planteose and stachyose so as to effectively inhibit oxidation of the base component and inhibit rise of the electric conductivity of the coolant. Thus, the electric conductivity of the coolant is maintained low for an extended period of time and oxidation is effectively inhibited.

What is claimed is:

1. A coolant composition for cooling a fuel cell unit, comprising a base component and at least one sugar alcohol for oxidation inhibition which is selected from the group consisting of erythritol, xylitol, sorbitol, mannitol, inositol, quercitol, palatinit, lactitol, maltitol, sucrose, raffinose, gentianose, melezitose, planteose and stachyose, wherein the coolant composition maintains the electric conductivity of the coolant at 10 μS/cm or below.

2. The coolant composition of claim 1, wherein said base component comprises at least one component selected from the group consisting of water, alcohols, glycols and glycol ethers.

3. The coolant composition of claim 2, wherein said base component comprises at least one component selected from the group consisting of methanol, ethanol, propanol, butanol, pentanol, hexanol, heptanol and octanol.

4. The coolant composition of claim 2, wherein said glycols are ethylene glycol, diethylene glycol, triethylene glycol, propylene glycol, 1,3-propanediol, 1,3-butanediol, 1,5-pentanediol and hexylene glycol.

5. The coolant composition of claim 2, wherein said glycol ethers are ethylene glycol monomethyl ether, diethylene glycol monomethyl ether, triethylene glycol monomethyl ether, tetraethylene glycol monomethyl ether, ethylene glycol monoethyl ether, diethylene glycol monoethyl ether, triethylene glycol monoethyl ether, tetraethylene glycol monoethyl ether, ethylene glycol monobutyl ether, diethylene glycol monobutyl ether, triethylene glycol monobutyl ether, and tetraethylene glycol monobutyl ether.

6. The coolant composition of claim 1, wherein said at least one sugar alcohol is contained at 0.1 wt % to 20.0 wt %.

7. A fuel cell comprising a coolant composition, the coolant composition comprising a base component and at least one sugar alcohol for oxidation inhibition which is selected from the group consisting of erythritol, xylitol, sorbitol, mannitol, inositol, quercitol, palatinit, lactitol, maltitol, sucrose, raffinose, gentianose, melezitose, planteose and stachyose.

8. The fuel cell of claim 7, wherein said base component comprises at least one component selected from the group consisting of water, alcohols, glycols and glycol ethers.

9. The fuel cell of claim 8, wherein said base component comprises at least one component selected from the group consisting of methanol, ethanol, propanol, butanol, pentanol, hexanol, heptanol and octanol.

10. The fuel cell of claim 8, wherein said glycols are ethylene glycol, diethylene glycol, triethylene glycol, propylene glycol, 1,3-propanediol, 1,3-butanediol, 1,5-pentanediol and hexylene glycol.

11. The fuel cell of claim 8, wherein said glycol ethers are ethylene glycol monomethyl ether, diethylene glycol monomethyl ether, triethylene glycol monomethyl ether, tetraethylene glycol monomethyl ether, ethylene glycol monoethyl ether, diethylene glycol monoethyl ether, triethylene glycol monoethyl ether, tetraethylene glycol monoethyl ether, ethylene glycol monobutyl ether, diethylene glycol monobutyl ether, triethylene glycol monobutyl ether, and tetraethylene glycol monobutyl ether.

12. The fuel cell of claim 7, wherein said at least one sugar alcohol is contained at 0.1 wt. % to 20.0 wt. %.

13. A method of making a fuel cell, comprising the step of contacting at least a portion of the fuel cell with a coolant composition, the coolant composition comprising a base component and at least one sugar alcohol for oxidation inhibition which is selected from the group consisting of erythritol, xylitol, sorbitol, mannitol, inositol, quercitol, palatinit, lactitol, maltitol, sucrose, raffinose, gentianose, melezitose, planteose and stachyose.

14. The method of claim 13, wherein said base component comprises at least one component selected from the group consisting of water, alcohols, glycols and glycol ethers.

15. The method of claim 14, wherein said base component comprises at least one component selected from the group consisting of methanol, ethanol, propanol, butanol, pentanol, hexanol, heptanol and octanol.

16. The method of claim 14, wherein said glycols are ethylene glycol, diethylene glycol, triethylene glycol, propylene glycol, 1,3-propanediol, 1,3-butanediol, 1,5-pentanediol and hexylene glycol.

17. The method of claim 14, wherein said glycol ethers are ethylene glycol monomethyl ether, diethylene glycol monomethyl ether, triethylene glycol monomethyl ether, tetraethylene glycol monomethyl ether, ethylene glycol monoethyl ether, diethylene glycol monoethyl ether, triethylene glycol monoethyl ether, tetraethylene glycol monoethyl ether, ethylene glycol monobutyl ether, diethylene glycol monobutyl ether, triethylene glycol monobutyl ether, and tetraethylene glycol monobutyl ether.

18. The method of claim 14, wherein said at least one sugar alcohol is contained at 0.1 wt. % to 20.0 wt. %.
